(19) United States
(12) Patent Application Publication
(10) Pub. No.: US 2025/0018508 A1
(43) Pub. Date: Jan. 16, 2025

(54) BRAZING SHEETS, ARTICLES FORMED FROM BRAZING SHEETS, AND METHODS OF FORMING ARTICLES

(71) Applicant: ARCONIC TECHNOLOGIES LLC, Pittsburgh, PA (US)

(72) Inventors: Andreas K. KULOVITS, Pittsburgh, PA (US); Harry R. ZONKER, Oakmont, PA (US)

(21) Appl. No.: 18/713,975

(22) PCT Filed: Oct. 24, 2022
(86) PCT No.: PCT/US2022/078582

§ 371 Date: May 28, 2024

Related U.S. Application Data
(60) Provisional application No. 63/265,942, filed on Dec. 23, 2021.

(51) Int. Cl. B23K 35/02; B23K 1/00; B23K 35/28; C22C 21/08

(52) U.S. Cl. CPC B23K 35/0238; B23K 1/0012; B23K 35/286; C22C 21/08

(57) ABSTRACT

Brazing sheets, articles formed from or including all or a portion of a brazing sheet, and methods of forming articles of manufacture are provided. A brazing sheet embodiment comprises a core layer, a brazing layer, and an interliner layer intermediate the core layer and the brazing layer. The core layer comprises a 6XXX series aluminum alloy having a core layer solidus temperature of at least 600° C. and comprising at least 0.3 weight percent magnesium based on a total weight of the 6XXX series aluminum alloy. The brazing layer comprises a 4XXX series aluminum alloy having a brazing layer solidus temperature lower than the core layer solidus temperature. The interliner layer comprises a first aluminum alloy comprising no greater than 0.5 weight percent manganese based on a total weight of the first aluminum alloy.

### FIELD OF USE

The present disclosure relates to brazing sheets, articles formed from or including brazing sheets, and methods of forming articles.

### BACKGROUND

Various apparatus, such as, for example, heat exchangers, may be formed from stacked specially designed metal plates. Plate-type heat exchangers function by circulating two fluids (e.g., liquid, a refrigerant, or combinations thereof) on opposite sides of a plate, allowing heat exchange between the fluids. To ensure that plate-type heat exchangers have acceptable corrosion resistance, the apparatus may be designed to resist corrosion attack along the joints between plates and through the thickness of the sheet material used to form the plates. Increasing the resistance to corrosion attack in plate-type heat exchangers can present significant challenges.

### SUMMARY

One non-limiting aspect according to the present disclosure is directed to a brazing sheet comprising a core layer, a brazing layer, and an interliner layer intermediate the core layer and the brazing layer. The core layer comprises a 6XXX series aluminum alloy having a core layer solidus temperature of at least 600° C. and comprising at least 0.3 weight percent magnesium based on a total weight of the 6XXX series aluminum alloy. The brazing layer comprises a 4XXX series aluminum alloy having a brazing layer solidus temperature lower than the core layer solidus temperature. The interliner layer comprises a first aluminum alloy comprising no greater than 0.5 weight percent manganese based on a total weight of the first aluminum alloy.

An additional non-limiting aspect according to the present disclosure is directed to a heat exchanger including at least one structural element comprising all or a portion of a brazing sheet comprising a core layer, a brazing layer, and an interliner layer intermediate the core layer and the brazing layer. The core layer comprises a 6XXX series aluminum alloy having a core layer solidus temperature of at least 600° C. and comprising at least 0.3 weight percent magnesium based on a total weight of the 6XXX series aluminum alloy. The brazing layer comprises a 4XXX series aluminum alloy having a brazing layer solidus temperature lower than the core layer solidus temperature. The interliner layer comprises a first aluminum alloy comprising no greater than 0.5 weight percent manganese based on a total weight of the first aluminum alloy.

Yet a further non-limiting aspect according to the present disclosure is directed to a method for forming an article. The method comprises contacting a first part comprising a first material with a second part comprising all or a portion of a brazing sheet, wherein the brazing sheet comprises a core layer, a brazing layer, and an interliner layer intermediate the core layer and the brazing layer. The core layer comprises a 6XXX series aluminum alloy having a core layer solidus temperature of at least 600° C. and comprising at least 0.3 weight percent magnesium based on a total weight of the 6XXX series aluminum alloy. The brazing layer comprises a 4XXX series aluminum alloy having a brazing layer solidus temperature lower than the core layer solidus temperature. The interliner layer comprises a first aluminum alloy comprising no greater than 0.5 weight percent manganese based on a total weight of the first aluminum alloy. The method comprises brazing the first part to the second part by a process comprising at least one of controlled atmospheric brazing and vacuum brazing.

It is understood that the inventions disclosed and described in this specification are not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The features and advantages of the examples, and the manner of attaining them, will become more apparent, and the examples will be better understood, by reference to the following description taken in conjunction with the accompanying drawing, wherein:

FIG. 1 is a schematic side elevational view of a non-limiting embodiment of a brazing sheet according to the present disclosure;

FIG. 2 is a schematic side elevational view of a non-limiting embodiment of a brazing sheet according to the present disclosure;

FIG. 3 is a schematic side elevational view of a non-limiting embodiment of a brazing sheet according to the present disclosure; and

FIG. 4 is a flow chart illustrating a non-limiting embodiment of a method for forming an article according to the present disclosure.

The exemplifications set out herein illustrate certain embodiments, in one or more forms, and such exemplifications are not to be construed as limiting the scope of the appended claims in any manner.

### DESCRIPTION OF NON-LIMITING EMBODIMENTS

Various embodiments are described and illustrated herein to provide an overall understanding of the structure, function, and use of the disclosed articles and methods. The various embodiments described and illustrated herein are non-limiting and non-exhaustive. Thus, an invention is not limited by the description of the various non-limiting and non-exhaustive embodiments disclosed herein. Rather, the invention is defined solely by the claims. The features and characteristics illustrated and/or described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, the applicant reserves the right to amend the claims to affirmatively disclaim features or characteristics that may be present in the prior art. The various embodiments disclosed and described in this specification can comprise, consist of, or consist essentially of the features and characteristics as variously described herein.

Any references herein to “various embodiments”, “some embodiments”, “one embodiment”, “an embodiment”, “a non-limiting embodiment”, or like phrases mean that a particular feature, structure, or characteristic described in connection with the example is included in at least one embodiment. Thus, appearances of the phrases “various embodiments”, “some embodiments”, “one embodiment”, “an embodiment”, “a non-limiting embodiment”, or like phrases in the specification do not necessarily refer to the same embodiment. Furthermore, the particular described features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments, without limitation. Such modifications and variations are intended to be included within the scope of the present embodiments.

The present inventors have determined that it can be desirable to provide a brazing sheet that is recyclable and has a suitable tensile yield strength. Brazing sheets typically include alloying elements that would be of value if they can be separated from used or scrapped brazing sheets or from used or scrapped articles of manufacture formed from or including the brazing sheets. It can be challenging to separate alloying elements from a brazing sheet or from an article including or formed from a brazing sheet. The present inventors have discovered that it may be desirable to limit the content of certain alloying elements, such as manganese, silicon, magnesium, and copper, in an aluminum alloy present in brazing sheet in order to enhance recyclability. For example, since the core layer is typically the thickest layer in the brazing sheet, a core layer comprising a high amount of manganese can make the brazing sheet unsuitable for recycling into 4XXX series aluminum. Similarly, the silicon content in the brazing layer and the zinc amount in the interliner layer and/or the core layer can affect recyclability. For example, having a high content of manganese, silicon, and/or zinc in the brazing sheet can affect the amount of the brazing sheet that could be added as scrap to a new 4XXX series aluminum alloy and much of the additional material added to the 4XXX series aluminum alloy would have to be pure. The present inventors have determined it is desirable to increase the amount of brazing sheets that can be added as scrap when forming new aluminum alloy sheets. If limiting the content of certain alloying elements in a brazing sheet to improve recyclability, it may be desirable to balance those chemistry modifications with alloying additions needed to provide desired properties in the brazing sheet, such as, for example, formability, tensile yield strength, corrosion resistance, and brazeability.

The present disclosure provides a brazing sheet that can exhibit an advantageous level of recyclability, along with acceptable or superior formability, corrosion resistance, brazeability, enhanced strength, and diffusion resistance. The brazing sheet according to the present disclosure can comprise a core layer, a brazing layer, and an interliner layer intermediate the core layer and the brazing layer. The core layer comprises a 6XXX series aluminum alloy having a core layer solidus temperature of at least 600° C. and comprising at least 0.3 weight percent magnesium based on the total weight of the 6XXX series aluminum alloy. The brazing layer comprises a 4XXX series aluminum alloy having a brazing layer solidus temperature lower than the core layer solidus temperature. The interliner layer comprises a first aluminum alloy comprising no greater than 0.5 weight percent manganese based on the total weight of the first aluminum alloy.

As used herein, the term “core layer” refers to a substrate layer of the brazing sheet. In various non-limiting embodiments, the “core layer” can be disposed substantially in the center of a brazing sheet. However, the position of the core layer in a brazing sheet according to the present disclosure is not limited to the center of a brazing sheet. The core layer may or may not be covered on both of its faces with another layer of the brazing sheet and, for example, the core layer can be disposed and partially or fully exposed on one side of the brazing sheet. Accordingly, in various non-limiting embodiments, the core layer of embodiments of a brazing sheet according to the present disclosure can be surrounded by other layers of the brazing sheet, have at least one side at least partially exposed, or have at least one side fully exposed.

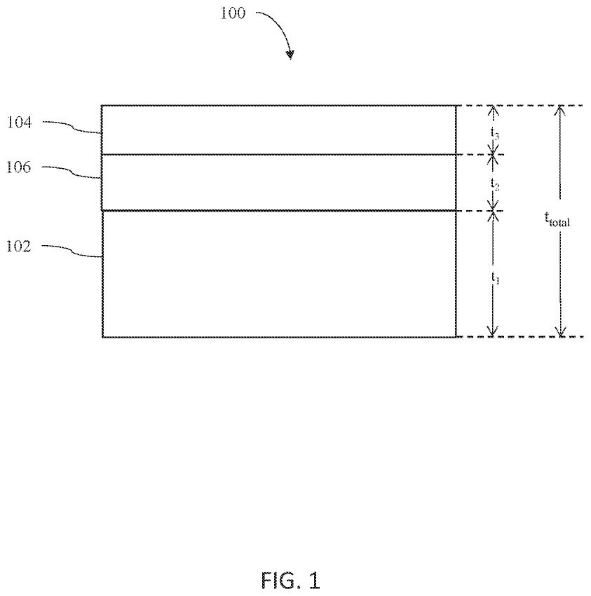

Referring to FIG. 1, a brazing sheet 100 is provided. The brazing sheet 100 comprises a core layer 102, a brazing layer 104, and an interliner layer 106 disposed intermediate the core layer 102 and the brazing layer 104. In various non-limiting embodiments, the core layer 102, the interliner layer 106, and the brazing layer 104 are bonded together to form the brazing sheet 100. The brazing sheet 100 can have a composition and thickness suitable for at least one of controlled atmospheric brazing and vacuum brazing.

The brazing sheet 100 can be subjected to brazing as part of a production process to form articles of manufacture. For example, brazing is a heat treatment process, where an article comprising a part and the brazing sheet 100 are heated to a temperature of at least the melting temperature of the brazing layer 104 such that the brazing liner 104 can melt and flow to wet a surface of a part and solidify to form a suitable braze joint with the part. The temperature can be sufficiently high to dissolve dissolvable phases (e.g., Mg₂Si) in the brazing sheet 100. Typically, for brazing, the article is heated to a temperature in a range of 590° C. to 610° C. The article is then cooled quickly, which can minimize the formation of dissolvable phases (e.g., Mg₂Si). Mg and Si can remain largely in solution.

During the brazing, it can be desirable that the core layer 102 does not melt such that the core layer 102 retains a desired strength, structural integrity, and corrosion performance. For example, the core layer 102 can comprise a core layer solidus temperature greater than a brazing temperature to which the brazing sheet 100 is subjected. For example, the core layer 102 can comprise a core layer solidus temperature of at least 600° C., such as, for example, at least 605° C., at least 610° C., or at least 615° C.

While limiting the manganese concentration in the core layer 102 can be desirable to increase recyclability of the brazing sheet 100, lowering the manganese content in the core layer 102 also may adversely affect other characteristics of the core layer 102 such as, for example, grain size and structure for example. Lowering the manganese content in the core layer 102 can decrease the core layer solidus temperature and/or decrease the strength of the core layer 102. Adding magnesium to the core layer 102 can increase the tensile yield strength of the core layer 102 and/or lower the core layer solidus temperature. The silicon, copper, iron, and zinc contents in the core layer 102 may also affect the core layer solidus temperature. Therefore, it can be desirable to adjust/balance the manganese, magnesium, silicon, copper, iron, and zinc contents in the core layer 102 to achieve a desirable recyclability, while also providing a desirable solidus temperature and a desirable strength for the core layer 102.

The core layer 102 of the brazing sheet 100 comprises an aluminum alloy, such as, for example, a 6XXX series aluminum alloy. The 6XXX series aluminum alloy of the core layer 102 can comprise at least 0.3 weight percent magnesium based on the total weight of the 6XXX series aluminum alloy, such as, for example, at least 0.4 weight percent magnesium based on the total weight of the 6XXX series aluminum alloy. The magnesium included in the core layer 102 can increase the strength of the core layer 102. In various embodiments of the brazing sheet 100, the 6XXX series aluminum alloy in the core layer 102 can be a 6061 aluminum alloy or a 6063 aluminum alloy. In various non-limiting embodiments, the core layer 102 comprises a 6XXX series aluminum alloy comprising, in weight percentages based on the total weight of the 6XXX series aluminum alloy: 0.3 to 1.0 magnesium; 0.2 to 1.0 silicon; 0 to 0.4 manganese; 0 to 0.3 copper; 0 to 0.8 iron; 0 to 0.3 zinc; 0 to 0.25 zirconium; 0 to 0.3 chromium; 0 to 0.5 bismuth; 0 to 0.25 titanium; aluminum; and impurities. In certain non-limiting embodiments, the core layer 102 comprises a 6XXX series aluminum alloy comprising, in weight percentages based on the total weight of the 6XXX series aluminum alloy: 0.55 to 0.9 magnesium; 0.4 to 0.9 silicon; 0.05 to 0.2 manganese; 0 to 0.2 copper; 0 to 0.2 iron; 0.02 to 0.2 zinc; 0 to 0.25 zirconium; 0 to 0.3 chromium; 0 to 0.5 bismuth; 0.05 to 0.15 titanium; aluminum; and impurities.

As used herein, impurities refers to non-purposeful additions of elements in an alloy. In certain non-limiting embodiments, the combined weight of all impurities that may be present is no greater than 0.15 weight percent based on the total weight of the alloy. In certain non-limiting embodiments, each individual impurity element may be present in an amount of no greater than 0.5 weight percent based on the total weight of the alloy.

The brazing layer 104 of the brazing sheet 100 comprises an aluminum alloy, such as, for example, a 4XXX series aluminum alloy. In various non-limiting embodiments, the brazing layer 104 comprises an aluminum alloy comprising, in weight percentages based on total weight of the aluminum alloy: 5 to 15 silicon; 0 to 2.0 magnesium; 0 to 1.0 iron; 0 to 3.0 zinc; 0 to 2.0 copper; 0 to 1.0 manganese; 0 to 0.3 bismuth; aluminum; and impurities. The brazing layer 104 exhibits a brazing layer solidus temperature that is lower than the core layer solidus temperature, such as, for example, at least 5° C. lower, at least 10° C. lower, at least 15° C. lower, at least 20° C. lower, at least 25° C. lower, or at least 30° C. lower than the core layer solidus temperature. The fact that the brazing layer solidus temperature is lower than the core layer solidus temperature enables a brazing process wherein heating the brazing sheet 100 to a suitable temperature melts the brazing layer 104, while the core layer 102 can remain substantially solid.

Referring to FIG. 1, the interliner layer 106 of the brazing sheet 100 comprises an aluminum alloy, such as, for example, a first aluminum alloy comprising no greater than 0.5 weight percent manganese based on the total weight of the first aluminum alloy. In various non-limiting embodiments, the first aluminum alloy comprises, in weight percentages based on total weight of the first aluminum alloy: 0.2 to 1.0 silicon; 0.05 to 0.5 manganese; 0 to 1.5 magnesium; 0 to 2.0 copper; 0 to 0.8 iron; 0 to 1.0 zinc; 0 to 0.2 zirconium; 0 to 0.3 chromium; 0 to 0.5 bismuth; 0 to 0.2 titanium; aluminum; and impurities. In certain non-limiting embodiments, the first aluminum alloy comprises, in weight percentages based on total weight of the first aluminum alloy: 0.5 to 0.8 silicon; 0.05 to 0.5 manganese; 0.5 to 1.5 magnesium; 0.1 to 2.0 copper; 0 to 0.2 iron; 0 to 1.0 zinc; 0 to 0.2 zirconium; 0 to 0.3 chromium; 0 to 0.5 bismuth; 0 to 0.2 titanium; aluminum; and impurities. In certain non-limiting embodiments, the first aluminum alloy comprises, in weight percentages based on total weight of the first aluminum alloy: 0.2 to 1.0 silicon; 0.05 to 0.5 manganese; 0 to 1.5 magnesium; 0 to 0.1 copper; 0 to 0.8 iron; 0 to 1.0 zinc; 0 to 0.2 zirconium; 0 to 0.3 chromium; 0 to 0.5 bismuth; 0 to 0.2 titanium; aluminum; and impurities. In various non-limiting embodiments, the Cu concentration in the first aluminum alloy is less than Cu concentration in the 6XXX series aluminum alloy of the core layer 102, which in certain non-limiting embodiments, may improve corrosion resistance of the brazing sheet 100.

In certain non-limiting embodiments, the composition of the interliner layer 106 may have a composition suitable for vacuum brazing (e.g., fluxless vacuum brazing). In various non-limiting embodiments in which the brazing sheet 100 is subjected to flux-free brazing (e.g., brazing in an inert atmosphere with residual O₂ in a CAB furnace without the use of any flux), magnesium diffusion from the interliner layer 106 and the core layer 102 can be advantageous, for example, to dissolve an oxide layer formed on the brazing layer 104 and/or facilitate wettability of the surface to be brazed. For example, magnesium may be present in the interliner layer 106 in a concentration greater than 0.5 weight percent, based on the total weight of the first aluminum alloy. In certain non-limiting embodiments, for example, the first aluminum alloy may comprise greater than 0.55 weight percent magnesium based on the total weight of the first aluminum alloy. In various non-limiting embodiments, the interliner layer 106 may enhance corrosion resistance of the brazing sheet 100.

In certain non-limiting embodiments, the first aluminum alloy that may be included in the interliner layer 106 comprises, in weight percentages based on total weight of the first aluminum alloy: 0.5 to 0.8 silicon; 0.05 to 0.5 manganese; 0.0 to 0.2 magnesium; 0.1 to 2.0 copper; 0 to 0.2 iron; 0 to 1.0 zinc; 0 to 0.5 zirconium; 0 to 0.3 chromium; 0 to 0.5 bismuth; 0 to 0.2 titanium; aluminum; and impurities. In certain non-limiting embodiments, the composition of the interliner layer 106 may be suitable for controlled atmospheric brazing. In various non-limiting embodiments in which the brazing sheet 100 is used with flux in a brazing process, magnesium diffusion from the interliner layer 106 and the core layer 102 may be inhibited. For example, magnesium may be present in the interliner layer 106 in a concentration no greater than 0.1 weight percent, based on the total weight of the first aluminum alloy, such as, for example, no greater than 0.05 weight percent, all based on the total weight of the first aluminum alloy.

In various non-limiting embodiments in which the brazing sheet 100 may be subjected to a brazing process utilizing a flux, magnesium diffusion from the brazing sheet 100 may be undesirable as it may interfere with the flux. In various non-limiting embodiments, the interliner layer 106 of the brazing sheet 100 is configured to inhibit diffusion from the core layer 102 to the brazing layer 104 (e.g., inhibit diffusion of magnesium). For example, the interliner layer 106 can be an unhomogenized material with a strain that can result in recrystallization of the interliner layer 106 during the braze cycle prior to liquid formation to prevent dissolution of materials into the brazing layer 104 when portions of the brazing sheet 100 liquefy during a brazing cycle. In various non-limiting embodiments, the interliner layer 106 can comprise at least 0.05 weight percent manganese based on the total weight of the interliner layer 106 such that the interliner layer 106 can form dispersoids to increase strength.

The thickness of each layer in the brazing sheet 100 can be configured based on the desired structural properties of the article (e.g., a heat exchanger) that is to be produced from or that is to incorporate the brazing sheet 100. For example, in various non-limiting embodiments, the core layer 102 can comprise a first thickness, t₁, that can be in a range of 60% to 90% of a total thickness (i.e., tₜₒₜₐₗ) of the brazing sheet 100. In various non-limiting embodiments, the interliner layer 106 can comprise a second thickness, t₂, that is in a range of 3% to 30% of a total thickness (tₜₒₜₐₗ) of the brazing sheet 100. In various non-limiting embodiments, the brazing layer 104 can comprise a third thickness, t₃, that is in a range of 3% to 20% of the total thickness (tₜₒₜₐₗ) of the brazing sheet 100. In various non-limiting embodiments, the first thickness, t₁, is greater than the second thickness, t₂, and also is greater than the third thickness, t₃. In certain non-limiting embodiments, the total thickness (tₜₒₜₐₗ) of the brazing sheet 100 is in a range of 100 μm to 5 mm, such as, for example, in a range of 200 μm to 1 mm.

In various non-limiting embodiments in which the brazing sheet 100 is subjected to a brazing process utilizing a flux, magnesium diffusion from the interliner layer 106 and the core layer 102 may be inhibited by forming a suitably thick interliner layer 106. For example, the second thickness, t₂, of the interliner layer 106 can be in a range of 10 μm to 1 mm, such as, for example, 50 μm to 1 mm, or 100 μm to 1 mm. In various non-limiting embodiments, the second thickness, t₂, of the interliner layer 106 can be at least 70 μm, such as, for example, at least 80 μm, at least 100 μm, at least 120 μm, at least 140 μm, or at least 150 μm.

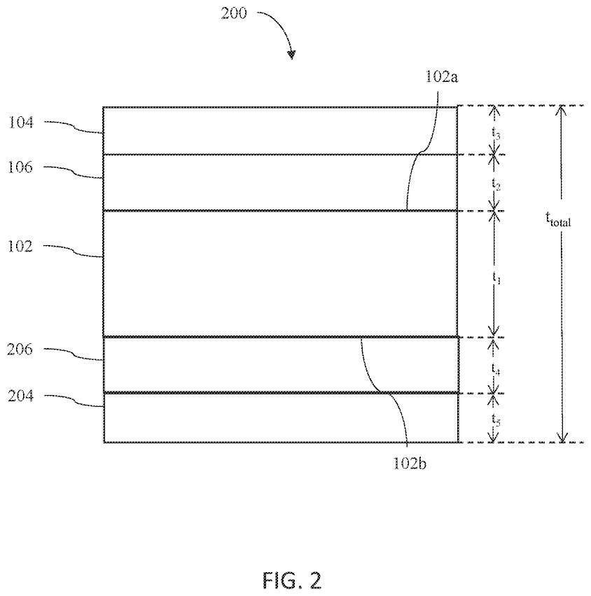

In various non-limiting embodiments, a brazing sheet according to the present disclosure may comprise one or more layers in addition to a core layer, an interliner layer, and a brazing layer. For example, referring to the non-limiting embodiment shown schematically in FIG. 2, a brazing sheet 200 comprises core layer 102, a first interliner layer 106, a first brazing layer 104, a second brazing layer 204, and a second interliner layer 206. In various non-limiting embodiments, the core layer 102, the first interliner layer 106, the second interliner layer 206, the first brazing layer 104, and the second brazing layer 204 are bonded together to form the brazing sheet 200. The brazing sheet 200 can be suitable for at least one of controlled atmospheric brazing and vacuum brazing. For example, the brazing sheet 200 can comprise layers having compositions so that the brazing sheet 200 is suitable for controlled atmospheric brazing and/or vacuum brazing. For example, in various non-limiting embodiments, for vacuum brazing, the first interliner layer 106 and second interliner layer 206 may be present in the brazing sheet 200.

As shown in FIG. 2, the first brazing layer 104 is disposed on a first side 102a of core layer 102, and the second brazing layer 204 is disposed on a second side 102b of core layer 102. The second side 102b of the core layer 102 is disposed opposite the first side 102a of the core layer 102. In various non-limiting embodiments, the second brazing layer 204 can be configured with a composition as described herein with respect to the brazing layer 104 of brazing sheet 100. In various non-limiting embodiments, a composition of the second brazing layer 204 can be the same as or different from a composition of the first brazing layer 104. Similarly, the second interliner layer 206 can be configured with a composition as described herein with respect to interliner layer 106 of brazing sheet 100. In various non-limiting embodiments, a composition of the second interliner layer 206 can be the same as or different from a composition of the first interliner layer 106.

With regard to brazing sheet 200, the second interliner layer 206 can be disposed intermediate the core layer 102 and the second brazing layer 204.

A thickness of each layer in the brazing sheet 200 can be configured based on the desired structural properties of the article to be produced from or that is to incorporate the brazing sheet 200. For example, in various non-limiting embodiments, the core layer 102 can comprise a first thickness, t₁, that can be in a range of 60% to 90% of a total thickness (tₜₒₜₐₗ) of the brazing sheet 200. In various non-limiting embodiments, the first interliner layer 106 and second interliner layer 206 can comprise a combined thickness, t₂+t₄, that is in a range of 3% to 30% of the total thickness (tₜₒₜₐₗ) of the brazing sheet 200. In various non-limiting embodiments, the first brazing layer 104 and the second brazing layer 204 can comprise a combined thickness, t₃+t₅, that is in a range of 3% to 20% of the total thickness (tₜₒₜₐₗ) of the brazing sheet 200. In certain non-limiting embodiments, the total thickness (tₜₒₜₐₗ) of the brazing sheet 200 is in a range of 100 μm to 5 mm, such as, for example, in a range of 200 μm to 1 mm.

The fourth thickness, t₄, of the second interliner layer 206 can be in a range of 10 μm to 1 mm, such as, for example, 50 μm to 1 mm, or 100 μm to 1 mm. In various non-limiting embodiments, the fourth thickness, t₄, of the second interliner layer 206 can be at least 70 μm, such as, for example, at least 80 μm, at least 100 μm at least 120 μm, at least 140 μm, or at least 150 μm.

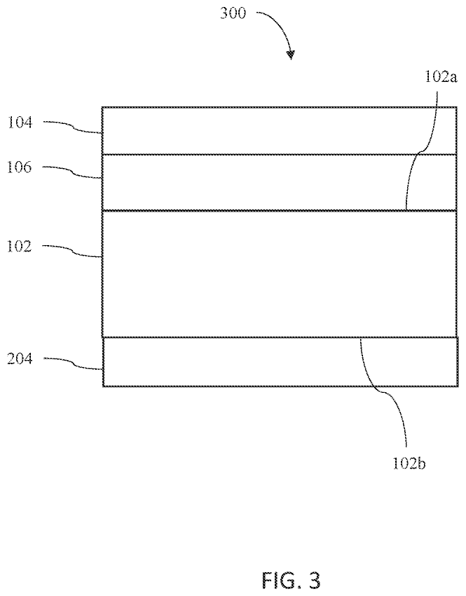

Referring to the non-limiting embodiment shown schematically in FIG. 3, brazing sheet 300 may be constructed so that it does not comprise the second interliner layer 206, and the second brazing layer 204 may be in direct contact with the core layer 102.

In various non-limiting embodiments, an article, such as, for example, a heat exchanger, can include one or more structural elements comprising all or a portion of brazing sheet 100, brazing sheet 200, brazing sheet 300, and/or a different embodiment of a brazing sheet according to the present disclosure. The heat exchanger can be, for example, an oil cooler, a battery cooling system (e.g., battery cooling system), or a liquid cooled condenser.

The brazing sheet 100, 200, 300 can have an advantageously high tensile yield strength and advantageously high formability. For example, the brazing sheet 100 can have a tensile yield strength of at least 40 MPa as evaluated according to ASTM B557, such as, for example, at least 50 MPa or at least 60 MPa, evaluated according to ASTM B557 in the as fabricated condition and prior to a brazing process and aging process and maintain a desirable formability. After a brazing process, the brazing sheet 100 can have a tensile yield strength of at least 60 MPa as evaluated according to ASTM B557, such as, for example, at least 70 MPa or at least 80 MPa, evaluated according to ASTM B557 in the as fabricated condition and prior to a brazing process and aging process. The brazing sheet 100 can have a tensile yield strength of at least 70 MPa as evaluated according to ASTM B557, such as, for example, at least 80 MPa, at least 100 MPa, at least 120 MPa, at least 150 MPa, at least 190 MPa, or at least 200 MPa, evaluated according to ASTM B557 after subjecting the brazing sheet 100, 200, 300, to a brazing process and aging process.

An aging process can comprise heating the brazing sheet 100, 200, 300 to a temperature that enables atomic mobility such that solute in solution can form strengthening phase precipitation. Typically, aging can include heating the brazing sheet 100, 200, 300 to a temperature in a range of 160° C. to 220° C.

The brazing sheet 100, 200, 300 can comprise a composition that is suitable or advantageous for recycling. For example, the brazing sheet 100, 200, 300 can comprise a composition suitable for recycling into a 6XXX series aluminum alloy. In various non-limiting embodiments, the brazing sheet 100, 200, 300 can be recycled into an 6XXX aluminum alloy suitable for use in the core layer 102 of the brazing sheet 100, 200, 300.

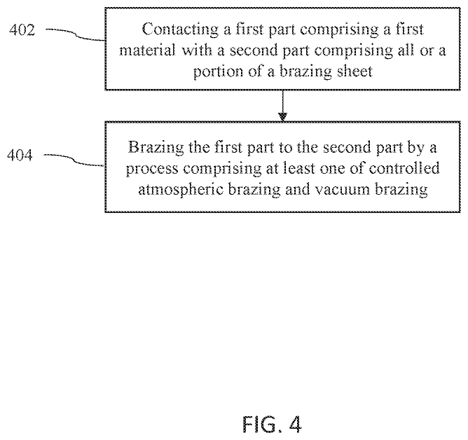

FIG. 4 provides a block diagram of a non-limiting embodiment of a method according to the present disclosure for forming an article of manufacture such as, for example, a heat exchanger. The method embodiment comprises contacting a first part comprising a first material with a second part comprising all or a portion of a non-limiting embodiment of a brazing sheet according to the present disclosure. For example, a non-limiting embodiment of a method according to the present disclosure may comprise contacting a first part comprising a first material with a second part comprising all or a portion of brazing sheet 100, brazing sheet 200, brazing sheet 300, and/or a different embodiment of a brazing sheet according to the present disclosure (FIG. 4, step 402). In various non-limiting embodiments, the first part can be brazed to the second part by a process comprising at least one of controlled atmospheric brazing and vacuum brazing (FIG. 4, step 404). In various embodiments, step 404 comprises controlled atmospheric brazing, wherein a flux is or is not used. For example, if the first interliner layer 106 and/or the second interliner layer 206, and the core layer 102 comprise a suitable concentration of magnesium, flux may not be required when conducting controlled atmospheric brazing. However, if the first interliner layer 106 and/or the second interliner layer 206, and the core layer 102 do not comprise a suitable concentration of magnesium, flux may be required when conducting controlled atmospheric brazing. In various non-limiting embodiments, the first material comprises aluminum or an aluminum alloy.

The following numbered clauses are directed to various non-limiting embodiments and aspects according to the present disclosure.

Clause 1. A brazing sheet comprising: a core layer comprising a 6XXX series aluminum alloy having a core layer solidus temperature of at least 600° C. and comprising at least 0.3 weight percent magnesium based on a total weight of the 6XXX series aluminum alloy; a brazing layer comprising a 4XXX series aluminum alloy having a brazing layer solidus temperature lower than the core layer solidus temperature; and an interliner layer intermediate the core layer and the brazing layer and comprising a first aluminum alloy comprising no greater than 0.5 weight percent manganese based on a total weight of the first aluminum alloy.

Clause 2. The brazing sheet of clause 1, wherein the 6XXX series aluminum alloy of the core layer is selected from a 6061 aluminum alloy and a 6063 aluminum alloy.

Clause 3. The brazing sheet of any of clauses 1 and 2, wherein the 6XXX series aluminum alloy of the core layer comprises, in weight percentages based on total weight of the 6XXX series aluminum alloy: 0.3 to 1.0 magnesium; 0.2 to 1.0 silicon; 0 to 0.4 manganese; 0 to 0.3 copper; 0 to 0.8 iron; 0 to 0.3 zinc; 0 to 0.25 zirconium; 0 to 0.3 chromium; 0 to 0.5 bismuth; 0 to 0.25 titanium; aluminum; and impurities.

Clause 4. The brazing sheet of any of clauses 1-3, wherein the 6XXX series aluminum alloy of the core layer comprises, in weight percentages based on total weight of the 6XXX series aluminum alloy: 0.55 to 0.9 magnesium; 0.4 to 0.9 silicon; 0.05 to 0.2 manganese; 0 to 0.2 copper; 0 to 0.2 iron; 0.02 to 0.2 zinc; 0 to 0.25 zirconium; 0 to 0.3 chromium; 0 to 0.5 bismuth; 0.05 to 0.15 titanium; aluminum; and impurities.

Clause 5. The brazing sheet of any of clauses 1-4, wherein the first aluminum alloy of the interliner layer comprises, in weight percentages based on total weight of the first aluminum alloy: 0.2 to 1 silicon; 0.05 to 0.5 manganese; 0.0 to 1.5 magnesium; 0 to 2.0 copper; 0 to 0.8 iron; 0 to 1.0 zinc; 0 to 0.2 zirconium; 0 to 0.3 chromium; 0 to 0.5 bismuth; 0 to 0.2 titanium; aluminum; and impurities.

Clause 6. The brazing sheet of any of clauses 1-5, wherein the first aluminum alloy of the interliner layer comprises, in weight percentages based on total weight of the first aluminum alloy: 0.5 to 0.8 silicon; 0.05 to 0.5 manganese; 0.5 to 1.5 magnesium; 0.1 to 2.0 copper; 0 to 0.2 iron; 0 to 1.0 zinc; 0 to 0.2 zirconium; 0 to 0.3 chromium; 0 to 0.5 bismuth; 0 to 0.2 titanium; aluminum; and impurities.

Clause 7. The brazing sheet of any of clauses 1-5, wherein the first aluminum alloy of the interliner layer comprises, in weight percentages based on total weight of the first aluminum alloy: 0.2 to 1 silicon; 0.05 to 0.5 manganese; 0.0 to 1.5 magnesium; 0 to 0.1 copper; 0 to 0.8 iron; 0 to 1.0 zinc; 0 to 0.2 zirconium; 0 to 0.3 chromium; 0 to 0.5 bismuth; 0 to 0.2 titanium; aluminum; and impurities.

Clause 8. The brazing sheet of any of clauses 1-5, wherein the first aluminum alloy of the interliner layer comprises, in weight percentages based on total weight of the first aluminum alloy: 0.5 to 0.8 silicon; 0.05 to 0.5 manganese; 0.0 to 0.2 magnesium; 0.1 to 2.0 copper; 0 to 0.2 iron; 0 to 1.0 zinc; 0 to 0.5 zirconium; 0 to 0.3 chromium; 0 to 0.5 bismuth; 0 to 0.2 titanium; aluminum; and impurities.

Clause 9. The brazing sheet of clause 8, wherein the interliner layer has a thickness of at least 70 μm.

Clause 10. The brazing sheet of any of clauses 1-5 and 8-9, wherein the brazing sheet has a composition suitable for controlled atmospheric brazing.

Clause 11. The brazing sheet of any of clauses 1-5 and 8-10, wherein the interliner layer inhibits diffusion from the core layer to the brazing layer.

Clause 12. The brazing sheet of any of clauses 1-11, wherein the 4XXX series aluminum alloy of the brazing layer comprises, in weight percentages based on total weight of the 4XXX series aluminum alloy: 5 to 15 silicon; 0 to 2.0 magnesium; 0 to 1.0 iron; 0 to 3.0 zinc; 0 to 2.0 copper; 0 to 1.0 manganese; 0 to 0.3 bismuth; aluminum; and impurities.

Clause 13. The brazing sheet of any of clauses 1-12, wherein the brazing sheet has a tensile yield strength of at least 70 MPa evaluated according to ASTM B557 after a brazing process and an aging process.

Clause 14. The brazing sheet of any of clauses 1-13, wherein the brazing sheet has a tensile yield strength of at least 100 MPa evaluated according to ASTM B557 after a brazing process and an aging process.

Clause 15. The brazing sheet of any of clauses 1-14, wherein the core layer, the interliner layer, and the brazing layer are bonded together into the brazing sheet.

Clause 16. The brazing sheet of any of clauses 1-15, wherein the brazing layer is a first brazing layer disposed on a first side of the core layer; and wherein the brazing sheet further comprises a second brazing layer disposed on a second side of the core layer, opposite the first side of the core layer, wherein the second brazing layer comprises a 4XXX series aluminum alloy.

Clause 17. The brazing sheet of clause 16, wherein the brazing sheet comprises a composition suitable for vacuum brazing.

Clause 18. The brazing sheet of any of clauses 1-17, wherein the interliner layer is a first interliner layer disposed on a first side of the core layer; and wherein the brazing sheet further comprises a second interliner layer is disposed on a second side of the core layer opposite the first side of the core layer, wherein the second interliner layer comprises an aluminum alloy.

Clause 19. The brazing sheet of any of clauses 1-18, wherein the interliner layer is a first interliner layer disposed on a first side of the core layer and the brazing layer is a first brazing layer disposed on a first interliner layer, and wherein the brazing sheet further comprises: a second interliner layer disposed on a second side of the core layer opposite the first side of the core layer, wherein the second interliner layer comprises an aluminum alloy; and a second brazing layer disposed on the second interliner layer, wherein the second brazing layer comprises a 4XXX series aluminum alloy.

Clause 20. The brazing sheet of any of clauses 1-19, wherein: the core layer comprises a first thickness in a range of 60% to 90% of a total thickness of the brazing sheet; each interliner layer comprises a second thickness in a range of 3% to 30% of the total thickness of the brazing sheet; and each brazing layer comprises a third thickness in a range of 3% to 20% of the total thickness of the brazing sheet.

Clause 21. A heat exchanger including a structural element comprising all or a portion of the brazing sheet of any of clauses 1-20.

Clause 22. A method for forming an article, the method comprising: contacting a first part comprising a first material with a second part comprising all or a portion of the brazing sheet of any of claims 1-19; and brazing the first part to the second part by a process comprising at least one of controlled atmospheric brazing and vacuum brazing.

Clause 23. The method of clause 22, wherein the first material comprises aluminum or an aluminum alloy.

Clause 24. The method of any of clauses 22-23, wherein the article is a heat exchanger.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The grammatical articles “a,” “an,” and “the,” as used herein, are intended to include “at least one” or “one or more,” unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural and the use of a plural noun includes the singular, unless the context of the usage requires otherwise.

One skilled in the art will recognize that the herein described articles and methods, and the discussion accompanying them, are used as examples for the sake of conceptual clarity and that various configuration modifications are contemplated. Consequently, as used herein, the specific examples/embodiments set forth and the accompanying discussions are intended to be representative of their more general classes. In general, use of any specific exemplar is intended to be representative of its class, and the non-inclusion of specific components, devices, operations/actions, and objects should not be taken to be limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

What is claimed is:

1. A brazing sheet comprising:
a core layer comprising a 6XXX series aluminum alloy having a core layer solidus temperature of at least 600° C. and comprising at least 0.3 weight percent magnesium based on a total weight of the 6XXX series aluminum alloy;
a brazing layer comprising a 4XXX series aluminum alloy having a brazing layer solidus temperature lower than the core layer solidus temperature; and
an interliner layer intermediate the core layer and the brazing layer and comprising a first aluminum alloy comprising no greater than 0.5 weight percent manganese based on a total weight of the first aluminum alloy.

2. The brazing sheet of claim 1, wherein the 6XXX series aluminum alloy of the core layer is selected from a 6061 aluminum alloy and a 6063 aluminum alloy.

3. The brazing sheet of claim 1, wherein the 6XXX series aluminum alloy of the core layer comprises, in weight percentages based on total weight of the 6XXX series aluminum alloy:
0.3 to 1.0 magnesium;
0.2 to 1.0 silicon;
0 to 0.4 manganese;
0 to 0.3 copper;
0 to 0.8 iron;
0 to 0.3 zinc;
0 to 0.25 zirconium;
0 to 0.3 chromium;
0 to 0.5 bismuth;
0 to 0.25 titanium;
aluminum; and
impurities.

4. The brazing sheet of claim 1, wherein the 6XXX series aluminum alloy of the core layer comprises, in weight percentages based on total weight of the 6XXX series aluminum alloy:
0.55 to 0.9 magnesium;
0.4 to 0.9 silicon;
0.05 to 0.2 manganese;
0 to 0.2 copper;
0 to 0.2 iron;
0.02 to 0.2 zinc;
0 to 0.25 zirconium;
0 to 0.3 chromium;
0 to 0.5 bismuth;
0.05 to 0.15 titanium;
aluminum; and
impurities.

5. The brazing sheet of claim 1, wherein the first aluminum alloy of the interliner layer comprises, in weight percentages based on total weight of the first aluminum alloy:
0.2 to 1 silicon;
0.05 to 0.5 manganese;
0.0 to 1.5 magnesium;
0 to 2.0 copper;
0 to 0.8 iron;
0 to 1.0 zinc;
0 to 0.2 zirconium;
0 to 0.3 chromium;
0 to 0.5 bismuth;
0 to 0.2 titanium;
aluminum; and
impurities.

6. The brazing sheet of claim 1, wherein the first aluminum alloy of the interliner layer comprises, in weight percentages based on total weight of the first aluminum alloy:
0.5 to 0.8 silicon;
0.05 to 0.5 manganese;
0.5 to 1.5 magnesium;
0.1 to 2.0 copper;
0 to 0.2 iron;
0 to 1.0 zinc;
0 to 0.2 zirconium;
0 to 0.3 chromium;
0 to 0.5 bismuth;
0 to 0.2 titanium;
aluminum; and
impurities.

7. The brazing sheet of claim 1, wherein the first aluminum alloy of the interliner layer comprises, in weight percentages based on total weight of the first aluminum alloy:
0.2 to 1 silicon;
0.05 to 0.5 manganese;
0.0 to 1.5 magnesium;
0 to 0.1 copper;
0 to 0.8 iron;
0 to 1.0 zinc;
0 to 0.2 zirconium;
0 to 0.3 chromium;
0 to 0.5 bismuth;
0 to 0.2 titanium;
aluminum; and
impurities.

8. The brazing sheet of claim 1, wherein the first aluminum alloy of the interliner layer comprises, in weight percentages based on total weight of the first aluminum alloy:
0.5 to 0.8 silicon;
0.05 to 0.5 manganese;
0.0 to 0.2 magnesium;
0.1 to 2.0 copper;
0 to 0.2 iron;
0 to 1.0 zinc;
0 to 0.5 zirconium;
0 to 0.3 chromium;
0 to 0.5 bismuth;
0 to 0.2 titanium;
aluminum; and
impurities.

9. The brazing sheet of claim 8, wherein the interliner layer has a thickness of at least 70 μm.

10. The brazing sheet of claim 1, wherein the brazing sheet has a composition suitable for controlled atmospheric brazing.

11. The brazing sheet of claim 1, wherein the interliner layer inhibits diffusion from the core layer to the brazing layer.

12. The brazing sheet of claim 1, wherein the 4XXX series aluminum alloy of the brazing layer comprises, in weight percentages based on total weight of the 4XXX series aluminum alloy:
5 to 15 silicon;
0 to 2.0 magnesium;
0 to 1.0 iron;
0 to 3.0 zinc;
0 to 2.0 copper;
0 to 1.0 manganese;
0 to 0.3 bismuth;
aluminum; and
impurities.

13. The brazing sheet of claim 1, wherein the brazing sheet has a tensile yield strength of at least 70 MPa evaluated according to ASTM B557 after a brazing process and an aging process.

14. The brazing sheet of claim 1, wherein the brazing sheet has a tensile yield strength of at least 100 MPa evaluated according to ASTM B557 after a brazing process and an aging process.

15. The brazing sheet of claim 1, wherein the core layer, the interliner layer, and the brazing layer are bonded together into the brazing sheet.

16. The brazing sheet of claim 1, wherein the brazing layer is a first brazing layer disposed on a first side of the core layer; and
the brazing sheet further comprises a second brazing layer disposed on a second side of the core layer, opposite the first side of the core layer, wherein the second brazing layer comprises a 4XXX series aluminum alloy.

17. The brazing sheet of claim 16, wherein the brazing sheet comprises a composition suitable for vacuum brazing.

18. The brazing sheet of claim 1, wherein the interliner layer is a first interliner layer disposed on a first side of the core layer; and
the brazing sheet further comprises a second interliner layer disposed on a second side of the core layer opposite the first side of the core layer, wherein the second interliner layer comprises an aluminum alloy.

19. The brazing sheet of claim 1, wherein the interliner layer is a first interliner layer disposed on a first side of the core layer, and the brazing layer is a first brazing layer disposed on the first interliner layer, and wherein the brazing sheet further comprises:
a second interliner layer disposed on a second side of the core layer opposite the first side of the core layer, wherein the second interliner layer comprises an aluminum alloy; and
a second brazing layer is disposed on the second interliner layer, wherein the second brazing layer comprises a 4XXX series aluminum alloy.

20. The brazing sheet of claim 1, wherein:
the core layer comprises a first thickness in a range of 60% to 90% of a total thickness of the brazing sheet;
each interliner layer comprises a second thickness in a range of 3% to 30% of the total thickness of the brazing sheet; and
each brazing layer comprises a third thickness in a range of 3% to 20% of the total thickness of the brazing sheet.

21. A heat exchanger including a structural element comprising all or a portion of the brazing sheet of claim 1.

22. A method for forming an article of manufacture, the method comprising:
contacting a first part comprising a first material with a second part comprising all or a portion of the brazing sheet of claim 1; and
brazing the first part to the second part by a process comprising at least one of controlled atmospheric brazing and vacuum brazing.

23. The method of claim 22, wherein the first material comprises aluminum or an aluminum alloy.

24. The method of claim 22, wherein the article of manufacture is a heat exchanger.
